(19) United States
(12) Patent Application Publication
(10) Pub. No.: US 2025/0202094 A1
(43) Pub. Date: Jun. 19, 2025

(54) FIXING MEMBER, ANTENNA SYSTEM, AND ELECTRONIC DEVICE

(71) Applicant: Beijing Zitiao Network Technology Co., Ltd., Beijing (CN)

(72) Inventors: Lishan HUANG, Beijing (CN); Guanghui LIU, Beijing (CN); Jiu XIA, Beijing (CN)

(21) Appl. No.: 18/849,320

(22) PCT Filed: Feb. 23, 2023
(86) PCT No.: PCT/CN2023/077957

§ 371 Date: Sep. 20, 2024

(30) Foreign Application Priority Data
Mar. 22, 2022 (CN) 202210286524.6

(51) Int. Cl. H01Q 1/22; H01Q 13/10

(52) U.S. Cl. CPC H01Q 1/22; H01Q 13/10

(57) ABSTRACT

The present disclosure relates to a fixing member, an antenna system, and an electronic device. A cross section of the fixing member (10) is annular, and a side wall of the fixing member (10) includes at least one first area (A); at least one first radiation slot (101) is arranged in the first area (A), and an extension direction of the first radiation slot (101) is consistent with a rotation direction of the fixing member (10); and the fixing member (10) is electrically connectable with a feed source to radiate wireless signals.

### CROSS-REFERENCE TO RELATED APPLICATION(S)

The present disclosure claims the priority of Chinese Patent Application No. 202210286524.6, filed on Mar. 22, 2022 and entitled “FIXING MEMBER, ANTENNA SYSTEM, AND ELECTRONIC DEVICE”, which is incorporated in its entirety herein by reference.

### FIELD

The present disclosure relates to the technical field of electronic products, and in particular to a fixing member, an antenna system, and an electronic device.

### BACKGROUND

A mobile communication technology basically iterates a new version every ten years, having currently undergone the development of 1G, 2G, 3G, and 4G. Each technological upgrade triggers industrial upgrading, and economic and social development. As a novel mobile communication network, 5G not only aims to achieve person-to-person communication, providing users with more immersive ultimate business experience such as augmented reality, virtual reality, and ultrahigh-definition (3D) videos, but also strives to solve problems about communication between people and things, as well as between things, meeting the application requirements of the Internet of Things such as mobile medical treatment, vehicle networking, smart homes, industrial control, and environmental monitoring. Ultimately, 5G will extend various industries and fields of economic society, becoming a critical new infrastructure that supports the digitalization, networking, and intelligent transformation of economic society.

However, in order to use the 5G technology, a plurality of antennas need to be separately set in an electronic device to respectively realize different communication functions of the electronic device. However, setting the plurality of antennas separately will significantly increase the manufacturing cost of the electronic device and also enlarge the size of the electronic device.

### SUMMARY

In order to solve the above technical problems or at least partially solve the above technical problems, the present disclosure provides a fixing member, an antenna system, and an electronic device.

In a first aspect, the present disclosure provides a fixing member.

A cross section of the fixing member is annular, and a side wall of the fixing member includes at least one first area: at least one first radiation slot is arranged in the first area, and an extension direction of the first radiation slot is consistent with a rotation direction of the fixing member; and

the fixing member is electrically connectable with a feed source to radiate wireless signals.

Further, the first radiation slot extends through the side wall of the fixing member.

Further, at least one second radiation slot is arranged in the first area, the second radiation slot extends through the side wall of the fixing member, and an extension direction of the second radiation slot intersects with the rotation direction of the fixing member.

Further, at least two first radiation slots are arranged in the first area; and
any two adjacent first radiation slots are in communication through the second radiation slot.

Further, the fixing member further includes a feed point and a ground point:
the feed point is used for being electrically connectable with the feed source to access a radio frequency signal; and
the ground point is used for grounding.

Further, the feed point is electrically connected with at least two feed sources through a single-pole multi-throw switch.

Further, the feed point is electrically connected with the single-pole multi-throw switch through a tuner.

Further, the side wall of the fixing member includes N first areas; the fixing member is provided with N ground points:
in the rotation direction of the fixing member, the first areas and the ground points are arranged at intervals; and
N is a positive integer greater than or equal to 2.

Further, the fixing member is used for being matched with a first component to form an accommodating cavity, and the accommodating cavity is used for fixing a second component.

Further, the first component is a circuit board, and the second component is a camera.

In a second aspect, the present disclosure further provides an antenna system. The antenna system includes a fixing member and a feed source; and
the fixing member is electrically connected with the feed source, and the fixing member is the above fixing member.

In a third aspect, the present disclosure further provides an electronic device. The electronic device includes a housing and a fixing member; and
the fixing member is installed on the housing, and the fixing member is the above fixing member.

Compared with the related art, the technical solutions provided by the embodiments of the present disclosure have the following advantages:
according to the technical solutions of the embodiments of the present disclosure, the fixing member is arranged to be electrically connected with the feed source so as to radiate the wireless signals, which essentially reuses the fixing member as an antenna, thereby achieving a wireless communication function. Therefore, by adopting the fixing member provided in this embodiment of the present disclosure, the number of antennas separately set in the electronic device can be reduced, thereby achieving the purposes of reducing the manufacturing cost of the electronic device, and also reducing the size of the electronic device.

In addition, according to the technical solutions of the embodiments of the present disclosure, by setting the extension direction of the first radiation slot to be consistent with the rotation direction of the fixing member, the first radiation slot is essentially allowed to extend in the rotation direction of the fixing member, thereby facilitating the production of a larger-sized first radiation slot in a limited space.

### BRIEF DESCRIPTION OF THE DRAWINGS

The accompanying drawings herein are incorporated into the specification to form a part of the specification, illustrate embodiments conforming to the present disclosure, and are used to explain the principle of the present disclosure together with the specification.

In order to describe the technical solutions in the embodiments of the present disclosure or in the related art more clearly, the accompanying drawings required to be used in descriptions of the embodiments or the prior art will be briefly introduced below, and it is apparent that those of ordinary skill in the art can obtain other accompanying drawings according to these accompanying drawings without creative work.

FIG. 1 is a schematic diagram of a three-dimensional structure of a fixing member according to an embodiment of the present disclosure;

FIG. 2 is a schematic diagram of a three-dimensional structure of another fixing member according to an embodiment of the present disclosure:

FIG. 3 is a schematic diagram of a partial structure of a first area in FIG. 2:

FIG. 4 is a schematic diagram of a partial structure of another first area according to an embodiment of the present disclosure:

FIG. 5 is a schematic diagram of a three-dimensional structure of another fixing member according to an embodiment of the present disclosure:

FIG. 6 and FIG. 7 are return loss curve graphs of wireless signals radiated by the fixing member with the radiation slot in the shape shown in FIG. 3:

FIG. 8 is a diagram of antenna efficiency of wireless signals radiated by the fixing member with the radiation slot in the shape shown in FIG. 3:

FIG. 9 is a return loss curve graph of wireless signals radiated by the fixing member with the radiation slot in the shape shown in FIG. 4:

FIG. 10 is a diagram of antenna efficiency of wireless signals radiated by the fixing member with the radiation slot in the shape shown in FIG. 4; and

FIG. 11 is a curve graph of an antenna isolation degree of the fixing member in FIG. 5.

### DETAILED DESCRIPTION OF EMBODIMENTS

To have a clearer understanding of the above objectives, features, and advantages of the present disclosure, the solution of the present disclosure is further described below: It should be noted that features of the embodiments and implementations in the present disclosure can be mutually combined without conflicts.

Many specific details are elaborated in the following description to facilitate a full understanding of the present disclosure, but the present disclosure may also be implemented in methods different from those described here. Obviously, the embodiments in the specification are only a part rather all of the embodiments of the present disclosure.

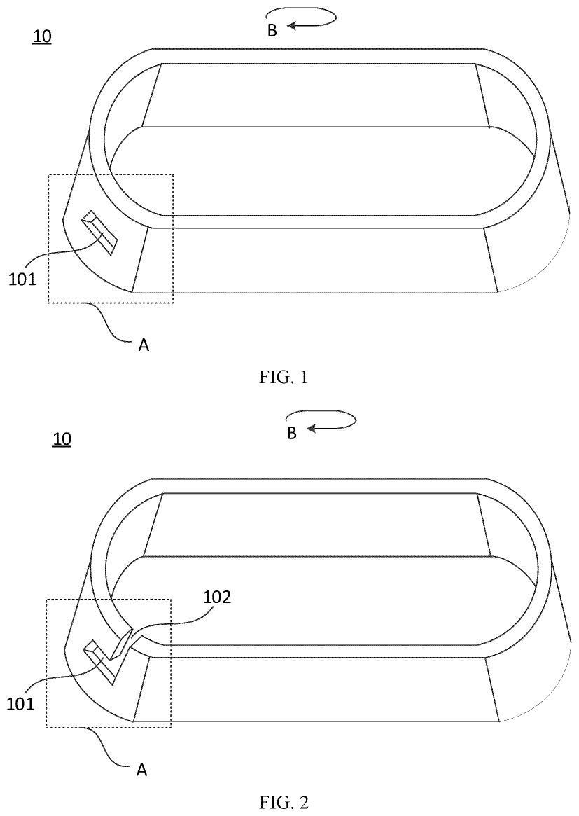

FIG. 1 is a schematic diagram of a three-dimensional structure of a fixing member according to an embodiment of the present disclosure. Referring to FIG. 1, a cross section of the fixing member 10 is annular. A side wall of the fixing member 10 includes at least one first area A (exemplarily, in FIG. 1, the side wall of the fixing member 10 only includes one first area A). At least one first radiation slot 101 is arranged in the first area 101, and an extension direction of the first radiation slot 101 is consistent with a rotation direction B of the fixing member 10. A material of the fixing member 10 is a conductive material. The fixing member 10) may be electrically connectable with a feed source to radiate wireless signals.

In this application, the cross section of the fixing member 10 is annular, namely a three-dimensional hollow structure presented by the remaining part after removing a middle part of the three-dimensional structure. Specifically, the cross section may be circular, racetrack-shaped, or other annular shapes.

In this application, the fixing member has two functions. The first function of the fixing member is to be matched with a first component to form an accommodating cavity, and the accommodating cavity is used for fixing a second component. In an example, the first component is a circuit board, and the second component is a camera. The second function of the fixing member is to serve as an antenna to achieve a wireless communication function. The fixing member may be used for radiating wireless signals in a plurality of frequency bands, such as radiating wireless signals in frequency bands of 2.4 GHZ-2.5 GHZ, 4.5 GHZ-7 GHZ, WiFi 2.4 GHZ, WiFi 5 GHZ, WiFi 6E, and N79.

In an embodiment, the first radiation slot extends through the side wall of the fixing member. Compared with a case that the first radiation slot does not extend through the side wall of the fixing member (in this case, the fixing member belongs to a slot antenna), and by arranging the first radiation slot to extend through the side wall of the fixing member, the antenna efficiency can be improved.

It should be noted that this application does not limit the size of the first radiation slot. In practice, the size of the first radiation slot needs to be set based on the frequency band of the wireless signal radiated by the fixing member. Specifically, in practice, the frequency band of the wireless signal required to be radiated by the fixing member is first determined, and then a return loss, antenna efficiency, and antenna surface current distribution, etc. when the fixing member radiates the wireless signal in this frequency band with different sizes of the first radiation slot are determined. The size of the first radiation slot of the fixing member that results in ideal return loss, antenna efficiency, and antenna surface current distribution is used as a final size.

Due to different frequency bands of wireless signals that the fixing member needs to radiate, the size of the first radiation slot may vary. In practice, there may be a case that the larger size of the first radiation slot needs to be set. By setting the extension direction of the first radiation slot to be consistent with the rotation direction of the fixing member, the first radiation slot is essentially allowed to extend in the rotation direction of the fixing member, thereby facilitating the production of a larger-sized first radiation slot in a limited space.

According to the above technical solution, the fixing member is arranged to be electrically connected with the feed source so as to radiate the wireless signals, which essentially reuses the fixing member as the antenna, thereby achieving the wireless communication function. Therefore, by adopting the fixing member provided in this embodiment of the present disclosure, the number of antennas separately set in the electronic device can be reduced, thereby achieving the purposes of reducing the manufacturing cost of the electronic device, and also reducing the size of the electronic device.

In some examples, the material of the fixing member is a conductive material.

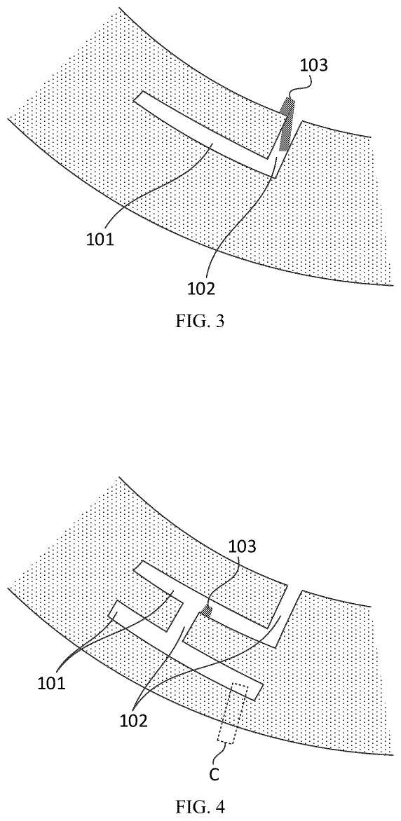

FIG. 2 is a schematic diagram of a three-dimensional structure of another fixing member according to an embodiment of the present disclosure. FIG. 3 is a schematic diagram of a partial structure of a first area in FIG. 2. Referring to FIG. 2 and FIG. 3, based on the above technical solution, in some examples, at least one second radiation slot 102 is arranged in the first area A. The second radiation slot 102 extends through the side wall of the fixing member 10), and an extension direction of the second radiation slot 102 intersects with the rotation direction B. The first radiation slot 101 communicates with the second radiation slot 102. Due to the arrangement, the goal of arranging a larger-sized radiation slot in a limited space can be achieved.

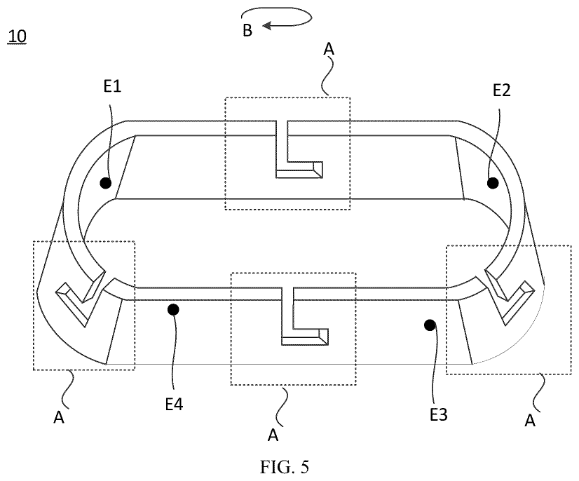

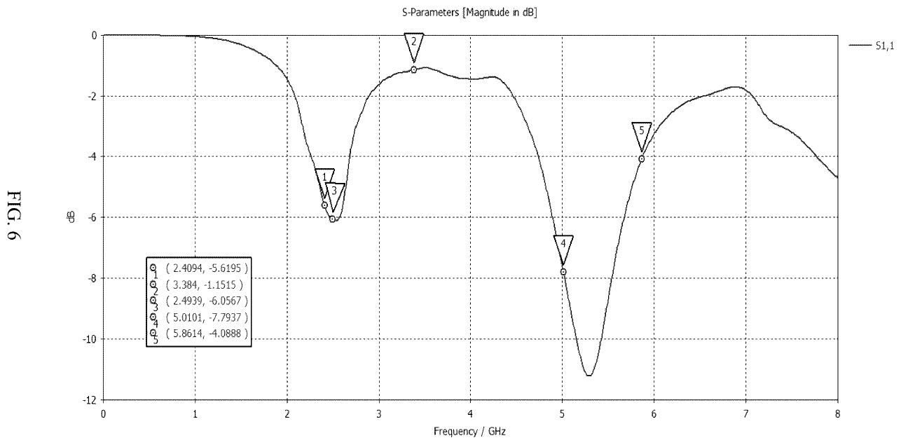

Further, FIG. 4 is a schematic diagram of a partial structure of another first area according to an embodiment of the present disclosure. Continuing to refer to FIG. 4, at least two first radiation slots 101 are arranged in the first area, and any two adjacent first radiation slots 101 are in communication through the second radiation slot 102. Due to the arrangement, the purpose of arranging a larger-sized radiation slot in a limited space can be achieved.

It should be noted that when the first radiation slot is arranged, it is necessary to ensure that the fixing member is in a closed state. The fixing member being in a closed state (i.e., no break joints) means that the fixing member is not broken and has no opening. Exemplarily, as shown in FIG. 4, if a part in an area C is removed, the fixing member is disconnected. This is because if the fixing member is disconnected, the fixing member is prone to deformation and cannot effectively fix the second component.

Further, the fixing member further includes a feed point and a ground point. The feed point is used for being electrically connectable with the feed source to access a radio frequency signal, and the ground point is used for grounding. The feed source may be, for example, arranged on the circuit board. The feed source may be used for providing a radio frequency signal. The radio frequency signal may be, for example, a 4G (the 4th generation mobile communication technology) signal, a 5G (the 5th generation mobile communication technology) signal, etc.

In some examples, referring to FIG. 3 and FIG. 4, the feed point is connected with the feed source of the circuit board through a first electrical connection line 103. The ground point is connected with a ground pin of the circuit board through a second electrical connection line.

If the side wall of the fixing member includes a plurality of first areas, in some examples, a feed point and a ground point are respectively arranged for each area.

In some examples, the feed point is electrically connected with at least two feed sources through a single-pole multi-throw switch. Exemplarily, if the circuit board is provided with a feed source that can provide 4G signals and a feed source that can provide 5G signals, the feed point is electrically connected with the two feed sources through a single-pole double-throw switch. Specifically, one input end of the single-pole double-throw switch is connected with the feed source that can provide 4G signals, the other input end is connected with the feed source that can provide 5G signals, and an output end is connected with the feed point of the fixing member. By adjusting a working state of the single-pole double-throw switch, the fixing member may be time-shared as a 4G signal antenna or a 5G signal antenna. Due to the arrangement, the number of antennas required to be arranged can be further reduced, thereby achieving the purposes of reducing the manufacturing cost of the electronic device, and also reducing the size of the electronic device.

Further, the feed point may also be set to be electrically connected with the single-pole multi-throw switch through a tuner. The tuner may allow impedance matching between different feed sources and the fixing member, thereby maximizing the radiated power of the antenna at any frequency.

Further, the side wall of the fixing member includes N first areas. The fixing member is provided with N ground points. In the rotation direction of the fixing member, the first areas and the ground points are arranged at intervals, and N is an integer greater than or equal to 2.

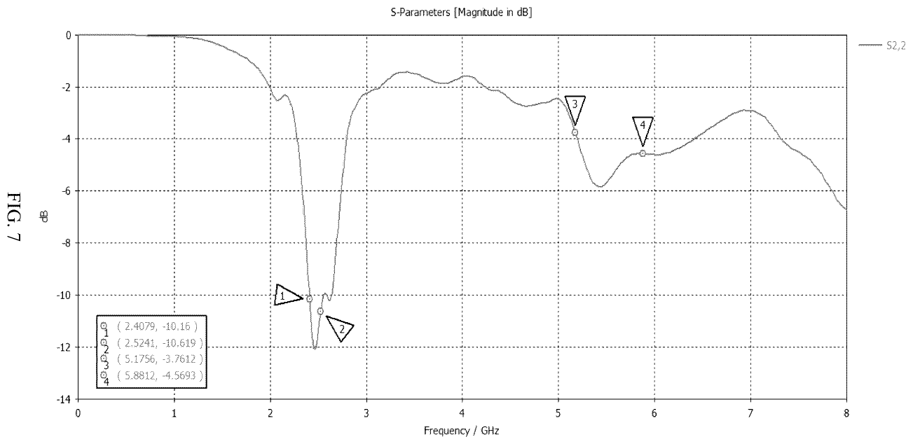

FIG. 5 is a schematic diagram of a three-dimensional structure of another fixing member according to an embodiment of the present disclosure. Exemplarily, referring to FIG. 5, the side wall of the fixing member 10 includes 4 first areas A. The fixing member 10 is provided with 4 ground points, namely a ground point E1, a ground point E2, a ground point E3, and a ground point E4. In the rotation direction of the fixing member 10, the first areas A and the ground points are arranged at intervals. Due to the arrangement, an isolation degree between the antennas can be improved.

The fixing member may be applied to an electronic device. The electronic device may be specifically a smartphone, a palmtop, a tablet, VR glasses, AR glasses, a desktop, a notebook computer, an all-in-one computer, a smart home device, or the like.

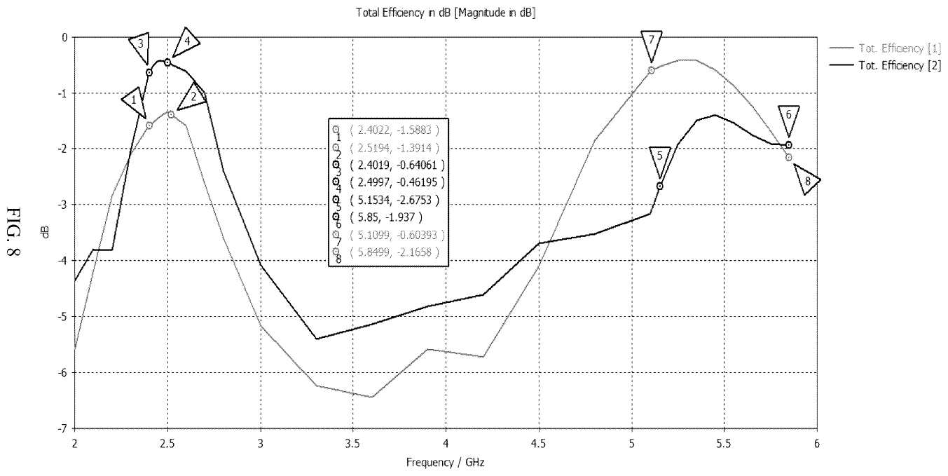

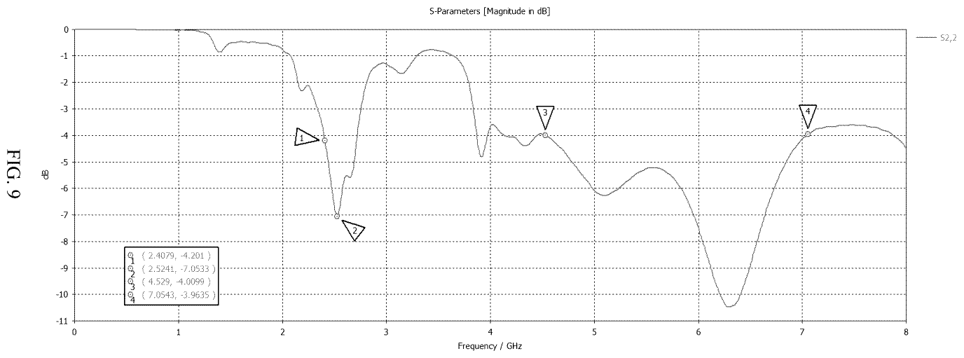

FIG. 6 and FIG. 7 show return loss curve graphs of wireless signals radiated by the fixing member with the radiation slot in the shape shown in FIG. 3. The radiation slots in FIG. 6 and FIG. 7 are different in size. FIG. 8 is a diagram of antenna efficiency of wireless signals radiated by the fixing member with the radiation slot in the shape shown in FIG. 3. In FIG. 8, radiation slot sizes corresponding to two curves are different.

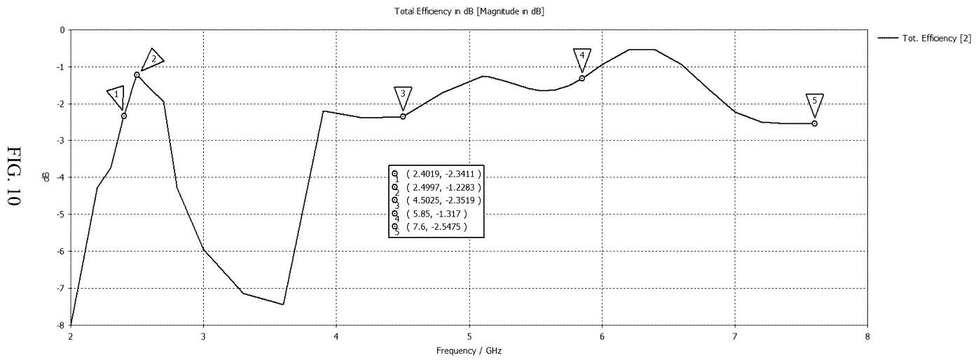

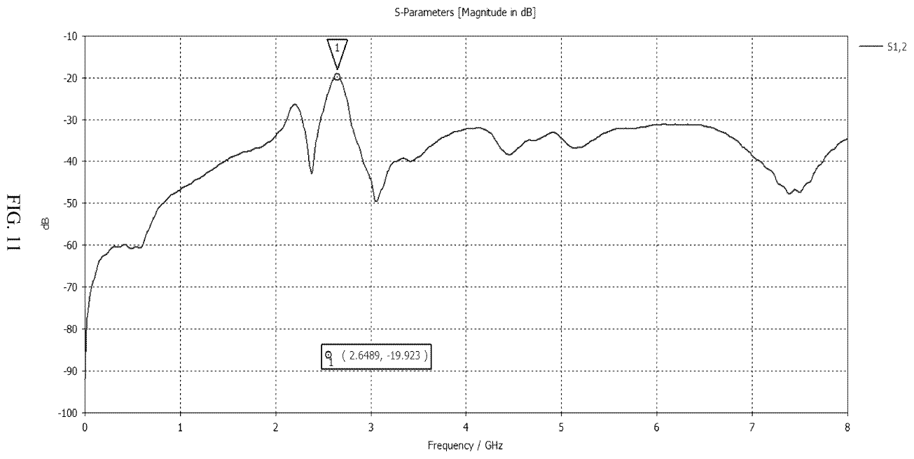

FIG. 9 is a return loss curve graph of wireless signals radiated by the fixing member with the radiation slot in the shape shown in FIG. 4. FIG. 10 is a diagram of antenna efficiency of wireless signals radiated by the fixing member with the radiation slot in the shape shown in FIG. 4.

FIG. 11 is a curve graph of an antenna isolation degree of the fixing member in FIG. 5. It can be seen from FIG. 11 that the isolation degree of the fixing member is basically 20 dB or below; and the isolation degree between the antennas is ideal.

The embodiments of the present disclosure further provide an antenna system. The antenna system includes a fixing member and a feed source. The fixing member is electrically connectable with the feed source. The fixing member is any one of the fixing members provided in the above embodiments.

Because the antenna system provided in this embodiment of the present disclosure includes any one of the above fixing members, the antenna system has the same or corresponding beneficial effects of the included fixing member, which are not repeated here.

The embodiments of the present disclosure further provide an electronic device. The electronic device includes a housing and a fixing member. The fixing member is installed on the housing. The fixing member is any one of the fixing members provided in the above embodiments.

The electronic device may be specifically a smartphone, a palmtop, a tablet, VR glasses, AR glasses, a desktop, a notebook computer, an all-in-one computer, a smart home device, etc.

Because the electronic device provided in this embodiment of the present disclosure includes any one of the above fixing members, the electronic device has the same or corresponding beneficial effects of the included fixing member, which are not repeated here.

The above contents are merely specific implementations of the present disclosure, such that those skilled in the art can understand or implement the present disclosure. More modifications for these embodiments are apparent to those skilled in the art, and general principles defined herein may be implemented in other embodiments without departing from the spirit or scope of the present disclosure. Therefore, the present disclosure will not be limited by these embodiments described herein but is required to conform to a widest scope consistent with the principles and novel characteristics disclosed herein.

1. A fixing member, wherein
a cross section of the fixing member is annular, and a side wall of the fixing member comprises at least one first area; at least one first radiation slot is arranged in the first area, and an extension direction of the first radiation slot is consistent with a rotation direction of the fixing member; and
the fixing member is electrically connectable with a feed source to radiate wireless signals.

2. The fixing member according to claim 1, wherein the first radiation slot extends through the side wall of the fixing member.

3. The fixing member according to claim 2, wherein at least one second radiation slot is arranged in the first area, the second radiation slot extends through the side wall of the fixing member, and an extension direction of the second radiation slot intersects with the rotation direction of the fixing member; and
the first radiation slot is in communication with the second radiation slot.

4. The fixing member according to claim 3, wherein at least two first radiation slots are arranged in the first area; and
any two adjacent first radiation slots are in communication through the second radiation slot.

5. The fixing member according to claim 1, wherein the fixing member further comprises a feed point and a ground point;
the feed point is used for electrical connection with the feed source to access a radio frequency signal; and
the ground point is used for grounding.

6. The fixing member according to claim 5, wherein
the feed point is electrically connected with at least two feed sources through a single-pole multi-throw switch.

7. The fixing member according to claim 6, wherein the feed point is electrically connected with the single-pole multi-throw switch through a tuner.

8. The fixing member according to claim 5, wherein the side wall of the fixing member comprises N first areas; N ground points is arranged on the fixing member;
in the rotation direction of the fixing member, the first areas and the ground points are arranged at intervals; and
wherein N is a positive integer greater than or equal to 2.

9. The fixing member according to claim 1, wherein
the fixing member is used for fitting with a first component to form an accommodating cavity, and the accommodating cavity is used for fixing a second component.

10. The fixing member according to claim 9, wherein
the first component is a circuit board, and the second component is a camera.

11. An antenna system, wherein the antenna system comprises a fixing member and a feed source;
the fixing member is electrically connected with the feed source to radiate wireless signals, wherein a cross section of the fixing member is annular, and a side wall of the fixing member comprises at least one first area; at least one first radiation slot is arranged in the first area, and an extension direction of the first radiation slot is consistent with a rotation direction of the fixing member.

12. An electronic device, wherein the electronic device comprises a housing and a fixing member; and
the fixing member is installed on the housing, wherein a cross section of the fixing member is annular, and a side wall of the fixing member comprises at least one first area; at least one first radiation slot is arranged in the first area, and an extension direction of the first radiation slot is consistent with a rotation direction of the fixing member; and the fixing member is electrically connectable with a feed source to radiate wireless signals.

13. The antenna system according to claim 11, wherein the first radiation slot extends through the side wall of the fixing member.

14. The antenna system according to claim 13, wherein at least one second radiation slot is arranged in the first area, the second radiation slot extends through the side wall of the fixing member, and an extension direction of the second radiation slot intersects with the rotation direction of the fixing member; and
the first radiation slot is in communication with the second radiation slot.

15. The antenna system according to claim 14, wherein at least two first radiation slots are arranged in the first area; and
any two adjacent first radiation slots are in communication through the second radiation slot.

16. The antenna system according to claim 11, wherein the fixing member further comprises a feed point and a ground point;
the feed point is used for electrical connection with the feed source to access a radio frequency signal; and
the ground point is used for grounding.

17. The antenna system according to claim 16, wherein
the feed point is electrically connected with at least two feed sources through a single-pole multi-throw switch.

18. The antenna system according to claim 17, wherein the feed point is electrically connected with the single-pole multi-throw switch through a tuner.

19. The antenna system according to claim 16, wherein the side wall of the fixing member comprises N first areas; N ground points is arranged on the fixing member;
in the rotation direction of the fixing member, the first areas and the ground points are arranged at intervals; and
wherein N is a positive integer greater than or equal to 2.

20. The antenna system according to claim 11, wherein
the fixing member is used for fitting with a first component to form an accommodating cavity, and the accommodating cavity is used for fixing a second component.
